(19) United States
(12) Patent Application Publication
(10) Pub. No.: US 2003/0090965 A1
(43) Pub. Date: May 15, 2003

(54) Optical disk player

(76) Inventors: Yuji Handa, Nagano (JP); Takashi Harada, Nagano (JP)

Correspondence Address: BIRCH STEWART KOLASCH & BIRCH, PO BOX 747, FALLS CHURCH, VA, 22040-0747, US

(21) Appl. No.: 10/286,912

(22) Filed: Nov. 4, 2002

(30) Foreign Application Priority Data
Nov. 9, 2001 (JP) 2001-344726

(51) Int. Cl. G11B 7/085

(52) U.S. Cl. 369/30.24

(57) ABSTRACT

The optical disk player of the present invention is capable of showing an actual cause of writing and/or reading errors. The optical disk player comprises control means for writing data onto and/or reading data from an optical disk and diagnosing an existence of a bad action while writing the diagnostic data. With this structure, the disk player is capable of solely diagnosing the existence of the bad action while writing and/or reading data.

### BACKGROUND OF THE INVENTION

The present invention relates to an optical disk player capable of writing data onto and/or reading data from an optical disk, e.g., CD, CD-ROM, CD-R, CD-RW.

An optical disk player, which writes and reads data, is usually connected to a host computer.

In some cases, data cannot be written or read while using the optical disk player. Writing and reading errors are caused by not only actual trouble of the optical disk player but also user's mistake, trouble of the host computer, bad connection with the host computer, etc. Namely, the errors are sometimes caused in spite of no trouble of the optical disk player.

In the cases of the writing and reading errors caused by user's mistake, the trouble of the host computer, the bad connection with the host computer, etc., the user cannot understand an actual cause of the errors, so the user usually thinks that the errors are caused by any trouble of the optical disk player. Therefore, he or she brings the optical disk player to a store or a repair station of a manufacturer. Further, the manufacturer must examine the optical disk player.

However, in the case of the errors caused by, for example, user's mistake, it is useless for the user and the manufacturer to bring and examine the optical disk player which has no trouble. If the user knows the actual cause of the errors, the useless action of the both parties can be omitted.

### SUMMARY OF THE INVENTION

An object of the present invention is to provide an optical disk player capable of showing an actual cause of writing and/or reading errors.

To achieve the object, the optical disk player of the present invention has following structures.

A first basic structure of the optical disk player comprises:

control means for writing diagnostic data onto an optical disk and diagnosing an existence of a bad action while writing the diagnostic data.

With this structure, the disk player is capable of solely diagnosing the existence of the bad action while writing the diagnostic data. Therefore, a user can know if the optical disk has any trouble of not. So, the user and a manufacturer can omit useless examination, etc.

In the optical disk player, the control means may continuously read the diagnostic data from the optical disk and diagnose the existence of the bad action, and

the control means may randomly read the diagnostic data from the optical disk and diagnose an existence of a bad access to the diagnostic data. With this structure too, the disk player is capable of solely diagnosing the existence of any trouble.

In the optical disk player, the control means may include:

means for generating random numbers; and

means for determining addresses of the optical disk,

from which the diagnostic data are read, on the basis of the generated random numbers, and

the control means may move an optical pick-up to the addresses determined by the determining means. With this structure, the optical disk player is capable of solely diagnosing if the optical pick-up can correctly jump to assigned addresses or not.

The optical disk player may further comprise memory means for storing a datum of the bad action if the control means detects the bad action. With this structure, the manufacturer can know the datum of trouble, so that the optical disk player can be correctly and quickly repaired.

A second basic structure of the optical disk player comprises:

control means for reading data, which have been previously written on an optical disk, from the optical disk and diagnosing an existence of a bad action while reading the data.

With this structure, the disk player is capable of solely diagnosing the existence of the bad action while reading the data. Therefore, a user can know if the optical disk has any trouble of not. So, the user and a manufacturer can omit useless examination, etc.

In the optical disk player, the control means may randomly read the data and diagnose an existence of a bad access to the data. With this structure too, the disk player is capable of solely diagnosing the existence of any trouble.

In the optical disk player, the control means may include:

means for generating random numbers; and

means for determining addresses of the optical disk,

from which the data are read, on the basis of the generated random numbers, and

the control means may move an optical pick-up to the addresses determined by the determining means. With this structure, the optical disk player is capable of solely diagnosing if the optical pick-up can correctly jump to assigned addresses or not.

The optical disk player may further comprise memory means for storing a datum of the bad action if the control means detects the bad action. With this structure, the manufacturer can know the datum of trouble, so that the optical disk player can be correctly and quickly repaired.

### BRIEF DESCRIPTION OF THE DRAWINGS

Embodiments of the present invention will now be described by way of examples and with reference to the accompanying drawings, in which:

FIG. 1 is a block diagram of the optical disk player of an embodiment of the present invention; and

FIGS. 2A and 2B are flowcharts showing a self-diagnosing action of the disk player.

### DETAILED DESCRIPTION OF THE EMBODIMENTS

Preferred embodiments of the present invention will now be described in detail with reference to the accompanying drawings.

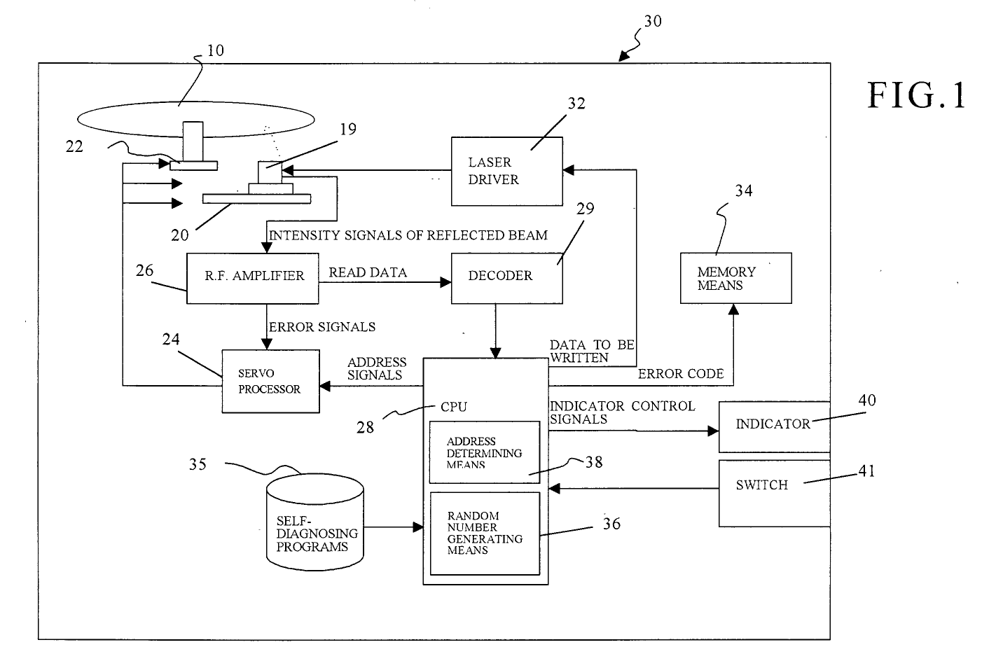

FIG. 1 shows a block diagram of the optical disk player of the present embodiment. Firstly, the structure will be explained.

The optical disk player 30 has an optical pick-up 19. The optical pick-up 19 includes a laser diode (not shown), which irradiates a laser beam toward an optical disk 10, and a photo detector (not shown), which receives a reflected beam reflected from the optical disk 10.

The optical pick-up 19 is moved, by a conveying mechanism 20, in a tracking direction of the optical disk 10. The conveying mechanism 20 includes a sled shaft (not shown), on which the optical pick-up 19 is slidably supported, a motor (not shown), etc.

The optical disk 10 is mounted on a turn table, which is fixed to a rotary shaft of a spindle motor 22. With this structure, the optical disk 10 is rotated by the spindle motor 22.

A servo processor 24 controls the spindle motor 22 which rotates the optical disk 10, a tracking and focusing action of an object lens (not shown) of the optical pick-up 19, and the conveying action of the conveying mechanism 20.

Intensity signals of the reflected beam reflected from the optical disk 10 are inputted to an RF amplifier 26, then the RF amplifier 26 extracts error signals. The servo processor 24 servo-controls the object lens, etc. on the basis of the error signals.

Further, the servo processor 24 servo-controls the conveying mechanism 20, on the basis of address signals from a CPU 28, so as to move the optical pick-up 19 to assigned addresses.

The CPU 28 acts as the control means on the basis of control programs, which have been previously stored in a memory unit. The CPU 28 sends control signals to the servo processor 24 on the basis of signals from a decoder 29, which decodes data extracted by the RF amplifier 26.

When data are written onto the optical disk 10, a laser driver 32 controls the laser diode of the optical pick-up 19.

Features of the present embodiment will be explained.

Even if the optical disk player 30 is not connected to a host computer or any other equipments, the CPU 28 is capable of self-diagnosing existence of writing errors and/or reading errors. When a user executes a prescribed action, the CPU 28 starts the self-diagnosing process. Self-diagnosing programs have been previously stored in a memory unit 35, e.g., ROM.

When the user executes the prescribed action, the CPU 28 reads the self-diagnosing programs from the memory unit 35 and starts a self-diagnosing mode on the basis of the programs.

In the present embodiment, the prescribed action comprises the steps of: disconnecting a cable from a host computer (not shown) or setting a jumper switch; and turning on a self-diagnosing switch 41. The switch 41 may be provided to any part of the optical disk player 30.

The CPU 28 includes a random number generating means 36 and an address determining means 38. The CPU 28 determines optional addresses on the basis of random numbers generated by the random number generating means 36 and sends the optional addresses to the servo processor 24. The servo processor 24 moves the optical pick-up 19 to the optional addresses determined by the CPU 28.

Memory means 34, e.g., RAM, is connected to the CPU 28. If an error occurs when data are written on the optical disk 10 or when data are read from the optical disk 10 or when the optical pick-up 19 is moved to the optional address, an error code of the error is stored in the memory means 34.

An indicator 40 indicating a present state of the optical disk player 30 is provided in a front panel of the optical disk player 30. The user can know the present state or action of the optical disk player 30 by watching the indicator 40. For example, the indicator 40 includes a green-colored LED and an orange-colored LED, so that the indicator 40 can irradiate green, orange and yellow light.

The CPU 28 also sends indicator control signals to the indicator 40 so as to control the indicator 40. The CPU 28 controls the indicator 40 on the basis of the present task of the CPU 28.

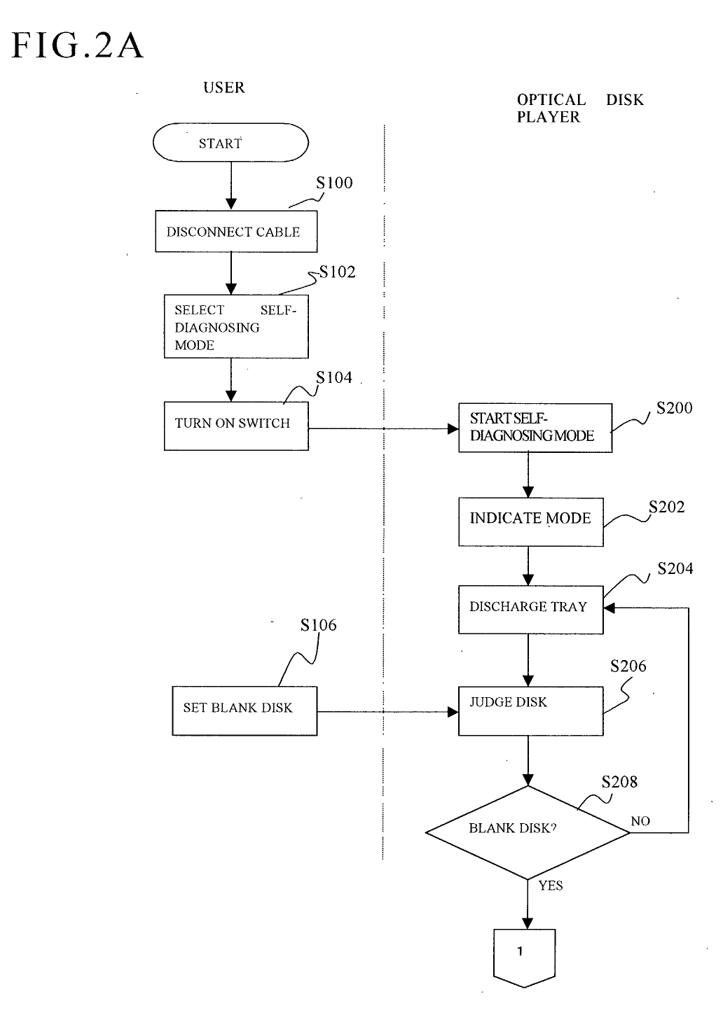

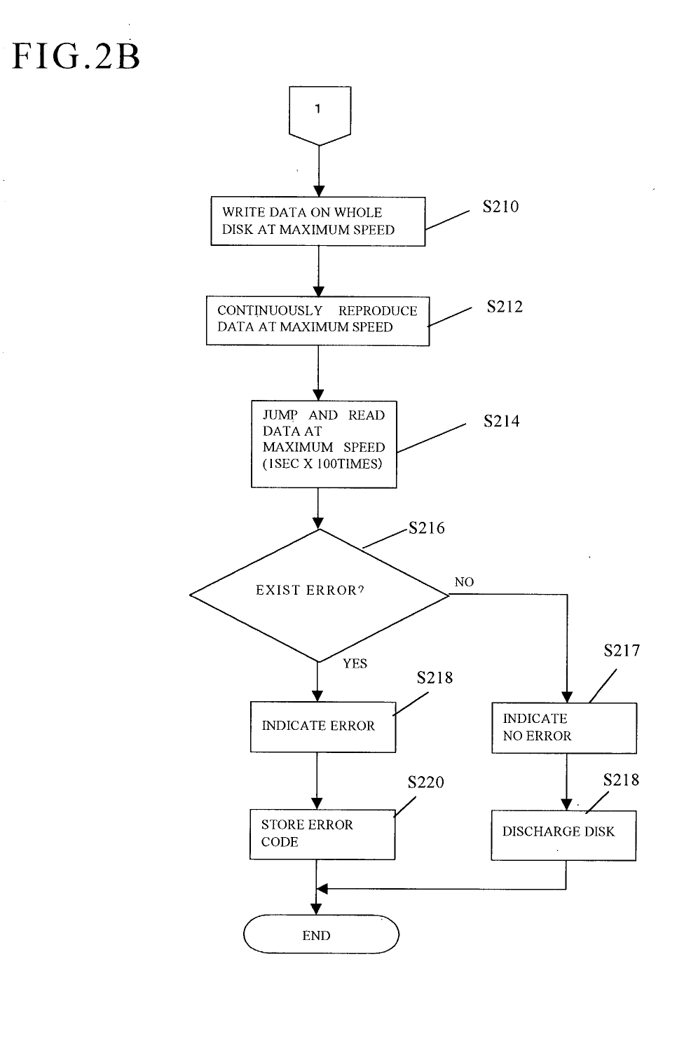

The action of the CPU 28 will be explained with reference to FIGS. 2A and 2B.

When a trouble of the optical disk player 30 occurs, the user firstly disconnects a cable (not shown) connected to the host computer (a step S100). Since the self-diagnosis is executed in this state in which the cable has been disconnected, a wrong diagnosis, in which the optical disk player 30 is diagnosed as a bad product in spite of no trouble, can be prevented. Namely, the optical disk player 30 is capable of independently self-diagnosing without reference to external equipments.

At a step S102, the user selects a mode of the jumper switch (not shown). The jumper switch is provided in a rear face of the optical disk player 30. The jumper switch is mainly used for initial setting. The self-diagnosing mode can be selected by the jumper switch.

At a step S104, the self-diagnosing mode of the optical disk player 30 is started by turning on the switch 41. For example, the switch 41 may be constituted by an eject button and an electric source switch (not shown). By simultaneously pushing the both, the self-diagnosing mode is started.

When the switch 41 is turned on, the CPU 28 reads the self-diagnosing programs from the memory unit 35 to start the self-diagnosing mode (a step S200).

At a step S202, the CPU 28 outputs the indicator control signals so as to alternately blink the green-colored LED and the orange-colored LED for 100 millisecond. With this action, the user can know that the optical disk player 30 starts the self-diagnosis.

At a step S204, the CPU 28 controls a tray mechanism (not shown) so as to discharge a tray. When the tray is discharged, the user mounts a blank disk onto the tray (a step S106). Then, the CPU 28 of the optical disk player 30 checks if the disk mounted is a blank disk or not (a step S206).

At a step S208, if the disk 10 mounted is a blank disk, the CPU 28 goes to a step S210; if the disk 10 mounted is not a blank disk, the CPU 28 returns to the step S204 and discharges the tray.

In the case that the blank disk 10 has been mounted on the tray, the CPU 28 writes data onto a whole disk 10 at maximum speed (the step S210). Note that, the data written on the disk 10 are meaningless data randomly selected by the CPU 28. The random data may be generated by the random number generating means 36.

By writing data on the whole disk 10, errors which have been occurred while writing data can be detected.

At a step S212, the CPU 28 continuously reads the data written at the step S210 at the maximum speed. Note that, the CPU 28 does not check if the data are correctly written or not. The CPU 28 checks sub-codes of the written data only. With this action, errors which have been occurred while continuously reading data from the disk 10 can be detected.

At a step S214, the CPU 28 makes the optical pick-up 19 jump to an optional address and read data there for a prescribed time, then jump to another optional address. These actions are repeated prescribed times.

The optional addresses are determined on the basis of random numbers generated by the random number generating means 38. In the present embodiment, data which have been written at the address to which the optical pick-up 19 has been jumped are read for one second. This action is repeated 100 times. By this manner, the CPU 28 can check if the optical pick-up 19 is capable of jumping to everywhere on the disk 10 or not.

At a step S216, if errors occur while writing data on the whole disk 10 (the step S210) or continuously reading data (the step S212) or randomly reading data (the step S214), the CPU 28 goes to a step S218; if no errors occur, the CPU 28 goes to a step S217.

At the step S218, the CPU 28 inform the fact of occurring errors to the user by the indicator 40. In the present embodiment, the indicator 40 blinks the green-colored LED once when errors occur while writing or reading data; the indicator 40 blinks the green-colored LED twice when errors occur while initializing.

At a step S220, the CPU 28 stores an error code corresponding to the errors in the memory means 34, then the self-diagnosis is completed. If errors are found and the self-diagnosis is completed, the tray is not discharged.

On the other hand, at the step S217, the CPU 28 turns off the indicator 40 so as to inform the fact of no error to the user.

At a step S219, the CPU 28 discharges the tray and completes the self-diagnosis.

Note that, errors of the optical disk player are, for example, an ejection error, a loading error, errors of reading PMA, TOC, ATIP, etc., an error of measuring linear velocity, an error of irradiating the laser diode, etc.

In the above described embodiment, data generated by the CPU 28 are written on the optical disk; verifying data is not executed while data are continuously read. However, in another embodiment, verifying data may be executed while data are continuously read so as to diagnose if the data have been correctly written or not.

The invention may be embodied in other specific forms without departing from the spirit or essential characteristics thereof. The present embodiments are therefore to be considered in all respects as illustrative and not restrictive, the scope of the invention being indicated by the appended claims rather than by he foregoing description and all changes which come within the meaning and range of equivalency of the claims are therefore intended to be embraced therein.

What is claimed is:

1. An optical disk player,
comprising:
control means for writing diagnostic data onto an optical disk and diagnosing an existence of a bad action while writing the diagnostic data.

2. The optical disk player according to claim 1,
wherein said control means continuously reads the diagnostic data from the optical disk and diagnoses the existence of the bad action, and
said control means randomly reads the diagnostic data from the optical disk and diagnoses an existence of a bad access to the diagnostic data.

3. The optical disk player according to claim 2,
wherein said control means includes:
means for generating random numbers; and
means for determining addresses of the optical disk, from which the diagnostic data are read, on the basis of the generated random numbers, and
said control means moves an optical pick-up to the addresses determined by said determining means.

4. The optical disk player according to claim 1,
further comprising memory means for storing details of the bad action if said control means detects the bad action.

5. An optical disk player,
comprising:
control means for reading data, which have been previously written on an optical disk, from the optical disk and diagnosing an existence of a bad action while reading the data.

6. The optical disk player according to claim 5,
wherein said control means randomly reads the data and diagnoses an existence of a bad access to the data.

7. The optical disk player according to claim 6,
wherein said control means includes:
means for generating random numbers; and
means for determining addresses of the optical disk, from which the data are read, on the basis of the generated random numbers, and
said control means moves an optical pick-up to the addresses determined by said determining means.

8. The optical disk player according to claim 5,
further comprising memory means for storing a datum of the bad action if said control means detects the bad action.
